(19) United States
(12) Patent Application Publication
(10) Pub. No.: US 2012/0109658 A1
(43) Pub. Date: May 3, 2012

(54) VOICE-CONTROLLED POWER DEVICE

(76) Inventor: Jui-Hsiung Wu, Taipei (TW)

(21) Appl. No.: 12/913,756

(22) Filed: Oct. 27, 2010

(51) Int. Cl. G10L 15/00

(52) U.S. Cl. 704/270; 704/E15.001

(57) ABSTRACT

A voice-controlled power device includes a voice-controlled circuit which includes a power module for getting an AC input voltage, a switch module having an electromagnetic relay and a driving circuit, and a control module having a microcontroller, a power unit regulating an output voltage of the power module and providing a work voltage for the microcontroller, a voice-detecting unit receiving voice signals and transforming the voice signals into electric signals, and a voice-amplifier unit amplifying the electric signals. The microcontroller receives and analyzes the amplified electric signals and sends out control signals to drive the driving circuit to control switch states of the electromagnetic relay and further control whether there is power output to an external electric appliance or not. The switch states of the electromagnetic relay rest with whether the output voltage of the power module is provided thereon or not under the control of the driving circuit.

### BACKGROUND OF THE INVENTION

1. Field of the Invention

The present invention generally relates to a power device, and more particularly to a voice-controlled power device.

2. The Related Art

Power devices, such as plugs, are generally employed to be connected with a power supply so as to make the power supply provide power for electric appliances. However, the electric appliances, such as computers, have many peripheral appliances used at the same time. If the power devices are always connected with the power supply with power switches of the electric appliances not yet turned off, then a circuit will always be formed to continually consume a current so that results in waste of power. In addition, the electric appliances having their power devices always connected with the power supply may shorten their life due to long-term use. So the users often need to pull out all the power devices or turn off all the power switches of the electric appliances. It is inconvenient to use.

### SUMMARY OF THE INVENTION

An object of the present invention is to provide a voice-controlled power device which includes an insulating housing, a plurality of conductive terminals fastened in the insulating housing and partially stretching out of the insulating housing for connecting with an AC power supply, and a voice-controlled circuit disposed in the insulating housing and including a power module, a control module and a switch module. The power module is connected with the conductive terminals for getting and dealing with an AC input voltage to output a proper output voltage. The control module includes a microcontroller, a power unit for regulating and filtering the output voltage of the power module and then providing a work voltage for the microcontroller, a voice-detecting unit for receiving voice signals and transforming the voice signals into electric signals, and a voice-amplifier unit for amplifying the electric signals and then transmitting amplified electric signals to the microcontroller. Then the microcontroller analyzes the amplified electric signals and sends out corresponding control signals. The switch module has an electromagnetic relay and a driving circuit. The driving circuit controls switch states of the electromagnetic relay according to the control signals from the control module, so as to further control whether the AC power supply outputs power to an external electric appliance or not. Wherein the switch states of the electromagnetic relay rest with whether the output voltage of the power module is provided thereon or not under the control of the driving circuit.

As described above, the voice-controlled power device utilizes the voice-detecting unit to receive the voice signal and further transform the voice signal into the electric signal, and then utilizes the voice-amplifier unit and the microcontroller to amplify and analyze the electric signal respectively, so as to drive the driving circuit to control the switch states of the electromagnetic relay, and further control whether there is power on the external electric appliance or not. Therefore, whether there is power provided for the external electric appliance can be conveniently controlled by means of a convenient operation of the voice-controlled power device.

### BRIEF DESCRIPTION OF THE DRAWINGS

The present invention will be apparent to those skilled in the art by reading the following description, with reference to the attached drawings, in which:

FIG. 1 is a view of a voice-controlled power device according to an embodiment of the present invention;

FIG. 2 is a block diagram of a voice-controlled circuit of the voice-controlled power device of FIG. 1;

FIG. 3 is a circuitry of a power module and a switch module of the voice-controlled circuit of FIG. 2; and

FIG. 4 is a circuitry of a control module of the voice-controlled circuit of FIG. 2.

### DETAILED DESCRIPTION OF THE PREFERRED EMBODIMENT

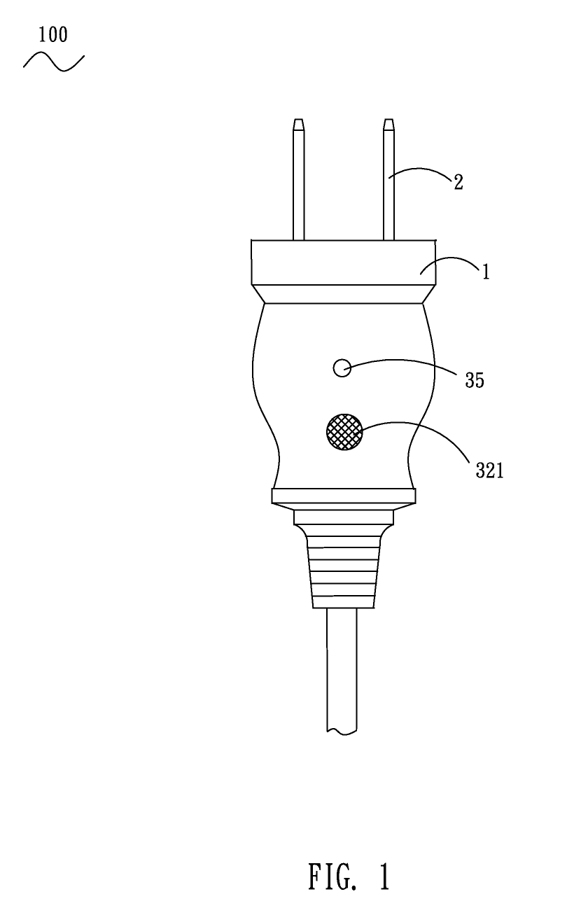

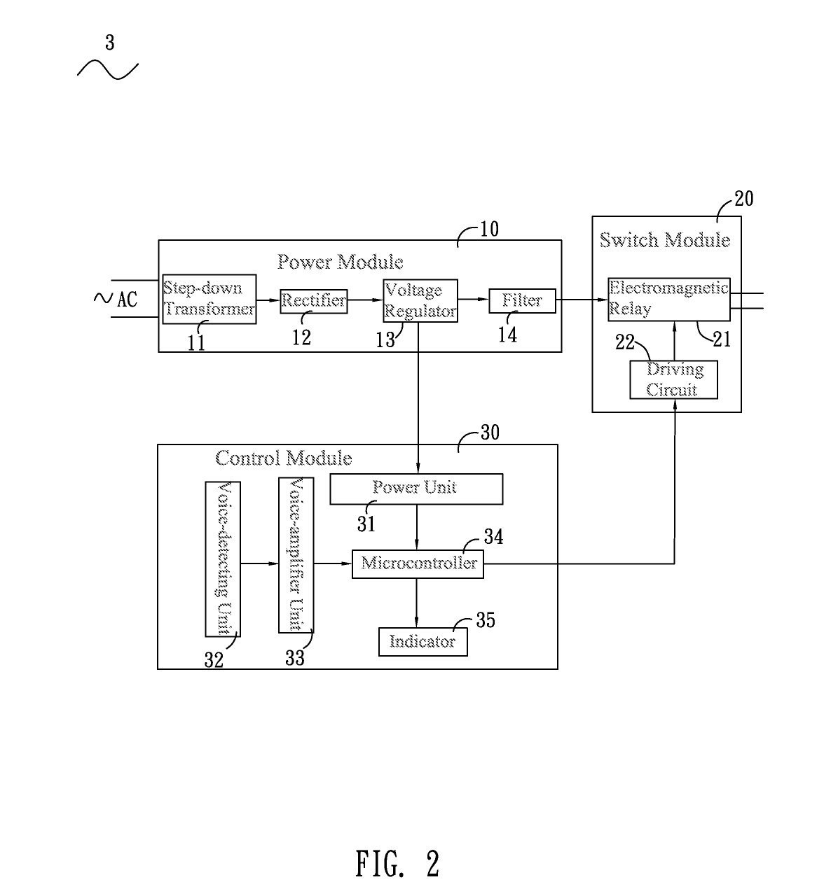

With reference to FIG. 1 and FIG. 2, a voice-controlled power device 100 according to an embodiment of the prevent invention includes an insulating housing 1, a plurality of conductive terminals 2 and a voice-controlled circuit 3. In this embodiment, the insulating housing 1 is an ordinary plug housing. The conductive terminals 2 are embedded in the insulating housing 1 and partially stretch out of the insulating housing 1 for connecting with an AC power supply. The voice-controlled circuit 3 is disposed in the insulating housing 1 and includes a power module 10, a switch module 20 and a control module 30.

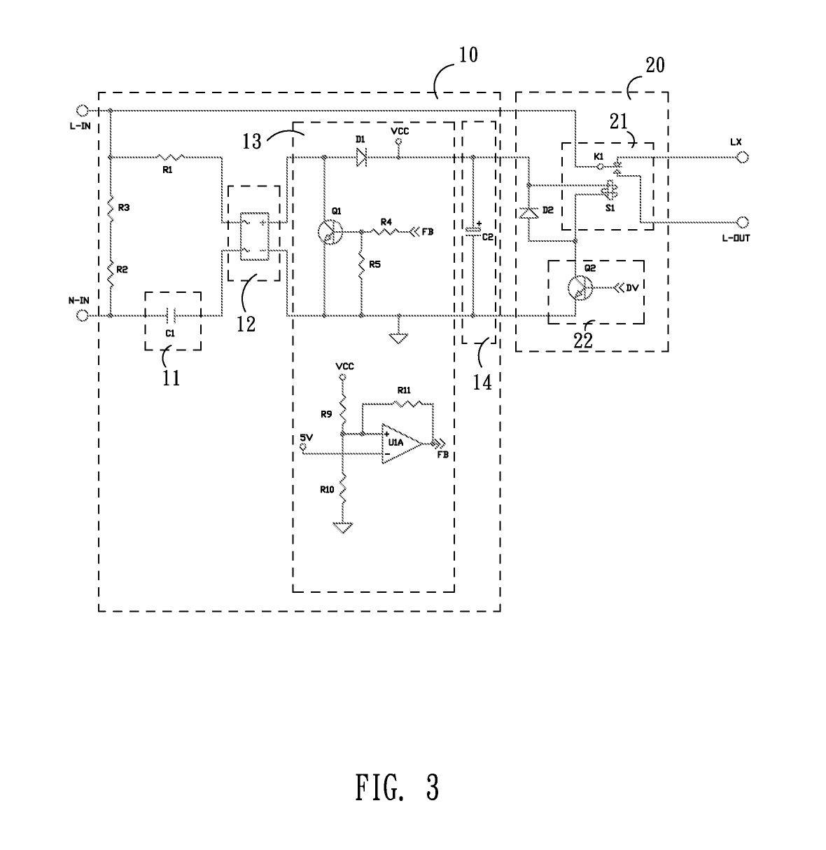

Referring to FIG. 2 and FIG. 3, the power module 10 is connected with the conductive terminals 2 for getting an AC input voltage. The power module 10 includes a step-down transformer 11, a rectifier 12, a voltage regulator 13 and a filter 14 which are successively connected together. The voltage regulator 13 has a comparator U1A and a first transistor Q1 of which the collector and the emitter are respectively connected to positive and negative output ports of the rectifier 12. The negative output port of the rectifier 12 is further connected to ground. The non-inverting input of the comparator U1A is connected between a first voltage-dividing resistor R9 and a second voltage-dividing resistor R10 connected in series. Another two terminals of the first and the second voltage-dividing resistors (R9, R10) are respectively connected to a positive output terminal VCC of the power module 10 and ground. The inverting input of the comparator U1A is connected with a standard voltage which will be defined later. The output of the comparator U1A is connected with the base of the first transistor Q1 so as to control switch states of the first transistor Q1 according to a voltage compared result of the non-inverting input with the inverting input. When the non-inverting input is at a higher voltage than the inverting input, namely a potential between the first voltage-dividing resistor R9 and the second voltage-dividing resistor R10 after an output voltage of the positive output terminal VCC is divided by the first and the second voltage-dividing resistors R9, R10 is higher than the standard voltage, the output of the comparator U1A outputs a positive voltage signal to control the first transistor Q1 connected. At this time, the positive output port of the rectifier 12 is short connected to ground, and the power module 10 has no voltage output. When the non-inverting input is at a lower voltage than the inverting input, namely the potential between the first voltage-dividing resistor R9 and the second voltage-dividing resistor R10 after the output voltage of the positive output terminal VCC is divided by the first and the second voltage-dividing resistors R9, R10 is lower than the standard voltage, the output of the comparator U1A outputs a negative voltage signal to control the first transistor Q1 disconnected. At this time, the power module 10 has a normal voltage output.

Referring to FIG. 2 and FIG. 3 again, the switch module 20 includes an electromagnetic relay 21 and a driving circuit 22. The driving circuit 22 has a second transistor Q2 of which the collector is connected to the positive output terminal VCC of the power module 10 through a directive diode D2, the emitter is connected to ground and the base is connected with the control module 30. The electromagnetic relay 21 is composed of a control system S1 parallel-connected to the directive diode D2, and a switch system K1 of which the stationary contact is connected with one of the conductive terminals 2, and one movable contact is drawn forth as an output for connecting with an external electric appliance, wherein switch states of the switch system K1 are controlled according to whether the output voltage of the power module 10 is output on the control system S1 or not.

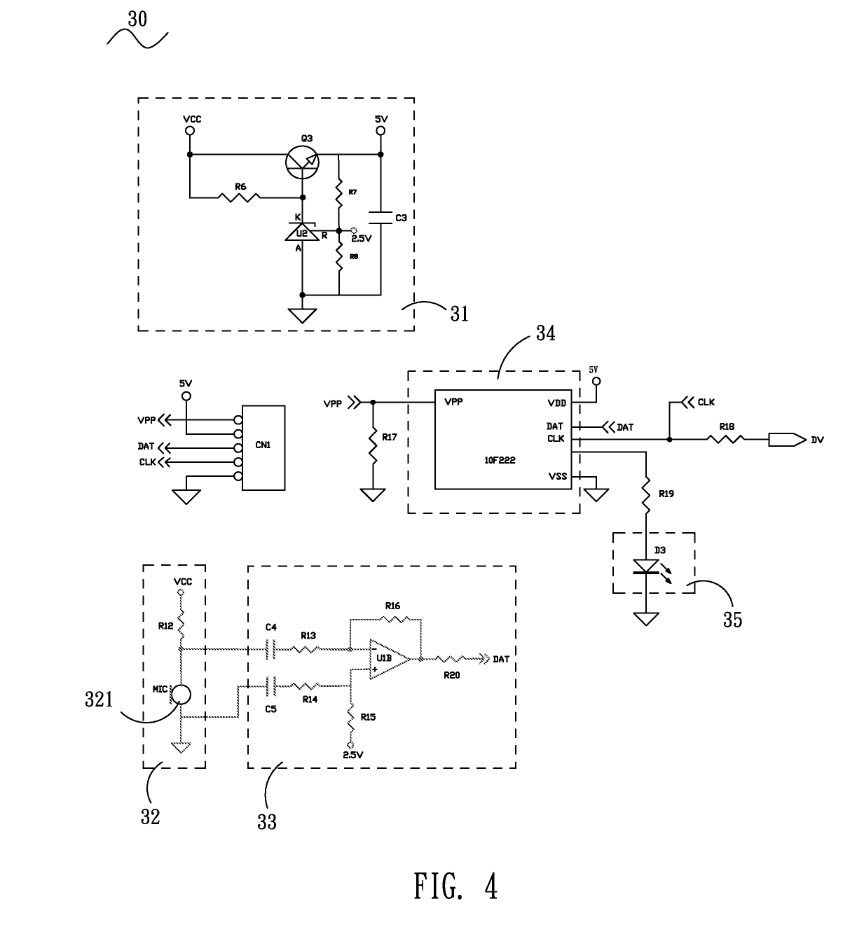

Referring to FIG. 1, FIG. 2 and FIG. 4, the control module 30 includes a power unit 31, a voice-detecting unit 32, a voice-amplifier unit 33, a microcontroller 34 and an indicator 35. The power unit 31 is connected between the power module 10 and the microcontroller 34, and can regulate and filter the output voltage of the power module 10 so as to provide a work voltage for the microcontroller 34. The power unit 31 includes a third transistor Q3 of which the collector is connected to the positive output terminal VCC of the power module 10, the base is on one hand connected to ground through a zener diode U2, and on the other connected to the collector through a first resistor R6, and the emitter successively passes through a second resistor R7 and a third resistor R8 to be connected to ground. The connection of the second resistor R7 and the third resistor R8 is drawn forth to be connected with a reference electrode R of the zener diode U2, and further acted as a reference terminal capable of providing a reference potential higher than 0V. The emitter of the third transistor Q3 is further connected with the microcontroller 34 so as to provide the work voltage for the microcontroller 34, wherein the work voltage is no other than the above mentioned standard voltage.

The voice-detecting unit 32 is used to receive voice signals and then transform the voice signals into electric signals. The voice-detecting unit 32 has a microphone 321 of which one terminal is connected to the positive output terminal VCC of the power module 10 through a fourth resistor R12, and the other terminal is connected to ground. The microphone 321 is embedded in the insulating housing 1. The voice-amplifier unit 33 receives the electric signals from the voice-detecting unit 32 and then amplifies the electric signals by means of an operational amplifier U1B. Two inputs of the operational amplifier U1B are connected to the two terminals of the microphone 321 respectively through a first capacitor C4 and a second capacitor C5. The microcontroller 34 is connected between the output of the operational amplifier U1B of the voice-amplifier unit 33 and the base of the second transistor Q2 of the driving circuit 22, for analyzing the amplified electric signals by the voice-amplifier unit 33, and then controlling a switch state of the second transistor Q2. In this embodiment, the microcontroller 34 is a chip of 10F222. The non-inverting input of the operational amplifier U1B is further connected with the reference terminal of the power unit 31 through an auxiliary resistor R15, for ensuring a lowest output voltage of the operational amplifier U1B always higher than 0V to the effect that the microcontroller 34 accurately analyzes the amplified electric signals. The indicator 35 is fastened in the insulating housing 1 and further connected with the microcontroller 34 so as to indicate whether there is power provided for the external electric appliance or not. In the embodiment, the indicator 35 is a light-emitting diode.

Referring to FIGS. 1-4, when the voice-detecting unit 32 receives a voice signal, the voice-detecting unit 32 transforms the voice signal into an electric signal. Then the voice-amplifier unit 33 amplifies the electric signal and further transmits the amplified electric signal to the microcontroller 34. The microcontroller 34 on one hand drives the indicator 35 to light, and on the other hand controls the second transistor Q2 of the driving circuit 22 in a connected state, by means of analyzing the amplified electric signal. After the second transistor Q2 is connected, the output voltage of the power module 10 is provided on the control system S1 of the electromagnetic relay 21. Therefore, the switch system K1 is closed, and the AC power supply outputs power to the external electric appliance. When the voice-detecting unit 32 receives a voice signal again, the indicator 35 is gone out and the second transistor Q2 is disconnected under the control of the microcontroller 34. As a result, the switch system K1 is opened due to the status of no voltage on the control system S1. So there is no power provided for the external electric appliance.

As described above, the voice-controlled power device 100 of the present invention utilizes the voice-detecting unit 32 to receive the voice signal and further transform the voice signal into the electric signal, and then utilizes the voice-amplifier unit 33 and the microcontroller 34 to amplify and analyze the electric signal respectively, so as to drive the driving circuit 22 to control switch states of the electromagnetic relay 21, and further control whether there is power on the external electric appliance or not. Therefore, whether there is power provided for the external electric appliance can be conveniently controlled by means of a convenient operation of the voice-controlled power device 100.

The foregoing description of the present invention has been presented for purposes of illustration and description. It is not intended to be exhaustive or to limit the invention to the precise form disclosed, and obviously many modifications and variations are possible in light of the above teaching. For example, the insulating housing 1 may be an ordinary socket housing or adapter housing. Such modifications and variations that may be apparent to those skilled in the art are intended to be included within the scope of this invention as defined by the accompanying claims.

What is claimed is:

1. A voice-controlled power device, comprising:
an insulating housing;
a plurality of conductive terminals fastened in the insulating housing and partially stretching out of the insulating housing for connecting with an AC power supply; and
a voice-controlled circuit disposed in the insulating housing and including:
a power module connected with the conductive terminals for getting and dealing with an AC input voltage to output a proper output voltage;
a control module including a microcontroller, a power unit for regulating and filtering the output voltage of the power module and then providing a work voltage for the microcontroller, a voice-detecting unit for receiving voice signals and transforming the voice signals into electric signals, and a voice-amplifier unit for amplifying the electric signals and then transmitting amplified electric signals to the microcontroller, then the microcontroller analyzing the amplified electric signals and sending out corresponding control signals; and
a switch module having an electromagnetic relay and a driving circuit, the driving circuit controlling switch states of the electromagnetic relay according to the control signals from the control module, so as to further control whether the AC power supply outputs power to an external electric appliance or not, wherein the switch states of the electromagnetic relay rest with whether the output voltage of the power module is provided thereon or not under the control of the driving circuit.

2. The voice-controlled power device as claimed in claim 1, wherein the voice-detecting unit is connected between a positive output terminal of the power module and ground, the voice-detecting unit has a microphone and a resistor series-connected with the microphone, the microphone is embedded in the insulating housing.

3. The voice-controlled power device as claimed in claim 2, wherein the voice-amplifier unit has an operational amplifier of which two inputs are connected to two terminals of the microphone respectively through a first capacitor and a second capacitor, and the output of the operational amplifier is connected with the microcontroller so as to send the amplified electric signals to the microcontroller.

4. The voice-controlled power device as claimed in claim 1, wherein the voice-controlled circuit further includes an indicator fastened in the insulating housing and connected with the microcontroller for indicating whether there is power output to the external electric appliance or not.

5. The voice-controlled power device as claimed in claim 1, wherein the power unit includes a transistor of which the collector is connected with a positive output terminal of the power module, the base is on one hand connected to ground through a zener diode, and on the other connected to the collector through a first resistor, and the emitter successively passes through a second resistor and a third resistor to be connected to ground, the connection of the second resistor and the third resistor is drawn forth to be connected with a reference electrode of the zener diode, the emitter of the transistor is further connected with the microcontroller to provide the work voltage for the microcontroller.

6. The voice-controlled power device as claimed in claim 5, wherein the connection of the second resistor and the third resistor is drawn forth to be further acted as a reference terminal capable of providing a reference potential higher than 0V, the voice-amplifier unit has an operational amplifier connected between the voice-detecting unit and the microcontroller, the non-inverting input of the operational amplifier is further connected with the reference terminal through an auxiliary resistor, for ensuring a lowest output voltage of the operational amplifier always higher than 0V to the effect that the microcontroller accurately analyzes the amplified electric signals.

7. The voice-controlled power device as claimed in claim 1, wherein the driving circuit of the switch module has a transistor of which the collector is connected to a positive output terminal of the power module through a directive diode, and the emitter is connected to ground, the electromagnetic relay comprises a control system parallel-connected to the directive diode and a switch system connected between one of the conductive terminals and the external electric appliance, the microcontroller of the control module is connected with the base of the transistor so as to control switch states of the transistor and further control whether the output voltage of the power module is provided on the control system or not.

8. The voice-controlled power device as claimed in claim 1, wherein the power module includes a step-down transformer, a rectifier, a voltage regulator and a filter which are successively connected together.

9. The voice-controlled power device as claimed in claim 1, wherein the insulating housing is a plug housing, a socket housing or an adapter housing.
